(19) United States
(12) Patent Application Publication
(10) Pub. No.: US 2026/0230558 A1
(43) Pub. Date: Aug. 6, 2026

(54) REAL-TIME END-OF-CALL PREDICTION

(71) Applicant: NICE LTD., Ra'anana (IL)

(72) Inventors: Jon ARROWOOD, Smyrna, GA (US); Asaf HAMO, Johns Creek, GA (US); Nahum LAZARUS, Tucker, GA (US)

(21) Appl. No.: 19/043,718

(22) Filed: Feb. 3, 2025

(51) Int. Cl. H04M 3/42; G10L 15/26; H04M 3/51

(52) U.S. Cl. CPC H04M 3/42221; G10L 15/26; H04M 3/5183; H04M 2201/40

(57) ABSTRACT

A system automatically display a summary of a customer-agent interaction before the end of the interaction. The system includes an agent computing device in communication with a contact center control system. Over a period of time, the system receives a group of interactions from a number of customers, and trains a machine learning model to assign an end-of-call probability weight to each phrase in the interactions. The system then receives a real-time interaction including a number of utterances, connects the interaction to the agent computing device, constructs a real-time transcript and, with the machine learning model, computes a cumulative end-of-call probability based on the utterances. When the end-of-call probability exceeds a threshold value the system constructs or updates a summary of the transcript, displays the summary, and performs at least one automated action based on the contents of the summary.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The subject matter described herein relates to devices, systems, and methods for predicting the end of a customer support interaction. This end-of-call prediction system has particular but not exclusive utility for supplying timely contact summaries to call center agents before the contact has ended.

### BACKGROUND

Automatic call summary systems for call centers and other contact centers may use a Large Language Model (LLM), such as Chat-GPT, Claude, or Mistral, to generate a summary at the end of each interaction. These summaries are then presented to the contact center agent, who can review for accuracy, and edit to remove unnecessary details or add any missing information. To generate the summary, a system prompt describing the task, plus a transcript of the interaction, are used as input to the LLM, which then runs in an inference mode and generates the summary as output, as requested in the system prompt.

Since a goal of automatic call summary systems is to automate after-call work, the summary needs to be available almost instantly, or else the agent cannot perform their review quickly or efficiently. A delay of even a few seconds can negatively impact productivity and undermine the purpose of automatic summarization. The problem is that current LLMs can sometimes require several seconds to generate their output.

When a summary delivered after the call is completed, the agent may miss opportunities to improve the customer experience. This includes opportunities to offer to services or alternate solutions to a problem that are included in the summary. Conversely, for the summary to be generated while the call is still taking place, a pause in the conversation, several seconds in length, may be needed to allow a conventional LLM time to produce its response. Such a delay may negatively impact the agent's efficiency and/or contribute to customer dissatisfaction.

It is therefore to be appreciated that such commonly used automatic call summary systems have numerous drawbacks, including time delays, efficiency impacts, customer satisfaction impacts, and otherwise. Accordingly, long-felt needs exist for improved call summary systems that address the forgoing and other concerns.

The information included in this Background section of the specification, including any references cited herein and any description or discussion thereof, is included for technical reference purposes only and is not to be regarded as subject matter by which the scope of the disclosure is to be bound.

### SUMMARY

Disclosed is an end-of-call prediction system that addresses the issue of LLM latency for summary generation, by running a lightweight end-of-call detector, and pre-emptively running the LLM summarization step before the end of the call. The end-of-call detector may for example be a non-LLM, lightweight model is used to monitor real-time automatic speech recognition (ASR) or chat interactions, and predict when an interaction is about to end. This allows the system to send the interaction to the LLM for auto-summary a few seconds before the actual end of the call. Thus, any latency required to generate the summary will be masked, creating a seamless experience for the customer while maximizing the efficiency and timeliness of the contact center agent.

The end-of-call prediction system disclosed herein has particular, but not exclusive, utility for providing a contact summary to the contact center agent while the contact is still ongoing, and without incurring a delay in the conversation. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system adapted to automatically display a summary of a customer-agent interaction before an end of the interaction. The system includes an agent computing device having a processor and a non-transitory computer readable medium operably coupled thereto, the agent computing device including a graphical user interface (GUI) and being in electronic communication with a contact center control system, the contact center control system may include: a real-time automated speech recognition system and a summary engine, the computer readable medium including a plurality of instructions stored in association therewith that are accessible to, and executable by, the processor, to perform operations. The operations may include: with the contact center control system, over a first period of time: receiving a first plurality of interactions from a plurality of customers, each interaction including a plurality of phrases and an end; and with a training system, training a machine learning model to assign an end-of-call probability weight to each phrase of the plurality of phrases, based on a proximity of each phrase to the end. The operations also include, with the contact center control system, at a time after the first period of time: receiving an interaction from a further customer different from the first plurality of interactions, the interaction including a plurality of utterances; connecting the interaction to the agent computing device; in real time, constructing a transcript of the utterances; in real time, with the trained machine learning model, computing a cumulative end-of-call probability based on the plurality of utterances that updates with each new utterance of the plurality of utterances; in real time, if the cumulative end-of-call probability exceeds a threshold value then, with the summary engine, constructing or updating a summary of the transcript; with the GUI, displaying a user control and the summary or the updated summary to an agent prior to an end of the interaction; when the user control is activated: saving the summary; and performing at least one automated action based on content within the summary or within the updated summary. Other embodiments of this aspect include corresponding computer systems, apparatus, and computer programs recorded on one or more computer storage devices, each configured to perform the actions of the methods.

Implementations may include one or more of the following features. In some embodiments, the at least one automated action may include sending the customer a document promised during the interaction, scheduling a follow-up call, scheduling a follow-up email, generating an interaction-appropriate survey, or transferring the interaction to a second agent. In some embodiments, the summary engine may include a large language model or the machine learning model may include a linear support vector machine. In some embodiments, displaying the summary and the user control prior to the end of the interaction results in a time savings for the agent, an improved user experience for the agent, or an improved customer experience for the customer. In some embodiments, the operations further may include: displaying the summary in an editable window; and receiving edits to the summary from the agent via the GUI. In some embodiments, the operations further May include: in real time, based on the transcript, determining at least one of a customer sentiment, a first customer behavior, or a second customer behavior. In some embodiments, the contact is a voice call, and constructing the transcript involves the real-time automated speech recognition system. In some embodiments, the contact is a text chat, and constructing the transcript involves storing text of the text chat. In some embodiments, the operations further may include sending an interaction-appropriate survey to the customer. In some embodiments, phrases with a high end-of-call probability weight may include social niceties with low information content, and excluding the social niceties from the summary has low impact on an information content of the summary. Implementations of the described techniques may include hardware, a method or process, or computer software on a computer-accessible medium.

One general aspect includes a method. The method includes, with a contact center control system including a real-time automated speech recognition system and a summary engine, over a first period of time: receiving a first plurality of interactions from a plurality of customers, each contact including a plurality of phrases and an end; and with a training system, training a machine learning model to assign an end-of-call probability weight to each phrase of the plurality of phrases, based on a proximity of each phrase to the end. The method also includes, with the contact center control system, at a time after the first period of time: receiving an interaction different from the first plurality of interactions from a customer different from the plurality of customers, the interaction including a plurality of utterances; connecting the interaction to an agent computing device; in real time, constructing a transcript of the utterances; in real time, with the trained machine learning model, computing a cumulative end-of-call probability based on the plurality of utterances that updates with each new utterance of the plurality of utterances; in real time, if the cumulative end-of-call probability exceeds a threshold value then, with the summary engine, constructing or updating a summary of the transcript; with a graphical user interface (GUI) running on the agent computing device, displaying a user control and the summary or the updated summary to an agent prior to an end of the interaction; and when the user control is activated: saving the summary; and performing at least one automated action based on content within the summary or within the updated summary. Other embodiments of this aspect include corresponding computer systems, apparatus, and computer programs recorded on one or more computer storage devices, each configured to perform the actions of the methods.

Implementations may include one or more of the following features. In some embodiments, the at least one automated action may include sending the customer a document promised during the interaction, scheduling a follow-up call, scheduling a follow-up email, generating an interaction-appropriate survey, or transferring the interaction to a second agent. In some embodiments, the summary engine may include a large language model or the machine learning model may include a linear support vector machine. In some embodiments, displaying the summary and the user control prior to the end of the contact results in a time savings for the agent, an improved user experience for the agent, or an improved customer experience for the customer. In some embodiments, the method may include: displaying the summary in an editable window; and receiving edits to the summary from the agent via the GUI. In some embodiments, the method may include: in real time, based on the transcript, determining at least one of a customer sentiment, a first customer behavior, or a second customer behavior. In some embodiments, the interaction is a voice call, and constructing the transcript involves the real-time automated speech recognition system. In some embodiments, the interaction is a text chat, and constructing the transcript involves storing text of the text chat. In some embodiments, the method may include sending an interaction-appropriate survey to the customer. In some embodiments, phrases with a high end-of-call probability weight may include social niceties with low information content, where excluding the social niceties from the summary has low impact on an information content of the summary. Implementations of the described techniques may include hardware, a method or process, or computer software on a computer-accessible medium.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the end-of-call prediction system, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a schematic, diagrammatic representation, in block diagram form, of a contact center, in accordance with at least one embodiment of the present disclosure.

FIG. 2 is a schematic, diagrammatic representation, in block diagram form, of an existing call summary system, in accordance with at least one embodiment of the present disclosure.

FIG. 3 is a schematic, diagrammatic representation, in block diagram form, of a call summary system that incorporates the end-of-call prediction system, in accordance with at least one embodiment of the present disclosure.

FIG. 4 is a sequence diagram showing the run-time operation of a linear support vector machine (SVM), in accordance with at least one embodiment of the present disclosure.

FIG. 5 is an example current auto summary sequence, without end-of-call detection, in accordance with at least one embodiment of the present disclosure.

FIG. 6 is an example auto summary sequence that incorporates the end-of-call prediction system, in accordance with at least one embodiment of the present disclosure.

FIG. 7 is a schematic, diagrammatic representation, in block diagram form, of an existing call summary system, in accordance with at least one embodiment of the present disclosure.

FIG. 8A is a test output for an example end-of-call prediction system, in accordance with at least one embodiment of the present disclosure.

FIG. 8B is a plot of precision vs. recall, in accordance with at least one embodiment of the present disclosure.

FIG. 9 is an example auto summary output that may for example be displayed on an agent computing device via the GUI, in accordance with at least one embodiment of the present disclosure.

FIG. 10 is a schematic, diagrammatic representation, in flow diagram form, of a call summary method that employs the end-of-call prediction system, in accordance with at least one embodiment of the present disclosure.

FIG. 11 is a schematic diagram of a processor circuit, in accordance with at least one embodiment of the present disclosure.

### DETAILED DESCRIPTION

In accordance with at least one embodiment of the present disclosure, an end-of-call prediction system is provided which can use words or phrases spoken or typed by the agent or customer during the contact, to identify when the end of the contact is imminent. This information can then be used to trigger the creation of a summary, which will be available to the agent before the end of the contact.

This end-of-call detection is accomplished by running a lightweight end-of-call detector, and pre-emptively running the LLM summarization step before the end of the call. A non-LLM, lightweight model is used to monitor real-time ASR or chat interactions, and predict when an interaction is about to end (the training and runtime characteristics for this model will be described below). This allows sending the interaction to auto-summary a few seconds before the actual end of the call. Thus, any latency required to generate the summary will be masked. To the agent, the summary will most likely be available before the end the interaction, which provides an opportunity to review the summary while the customer is still on the line, and see if there are any questions or actions they need to take prior to the customer disconnecting.

Furthermore, since the summary is available before the end of the call, either the summary or the interaction text itself can be used to perform additional actions before the customer disconnects, including specific, targeted actions based on the summary or possibly recommended within the summary. One of these, for example, is using an LLM to generate an “interaction appropriate” survey ready for the user. Another possible action is a new product recommendation based on a need mentioned during the call by the customer, as opposed to identifying such a need post-call and initiating the sales process at a later time. Another example could be to transfer the customer to a different agent that could address an unresolved matter brought up during the call. This allows customers to address their needs within a single session without having to call back. A summary given to—the agent prior the disconnecting can also help the agent identify if a follow-up call is warranted and can offer this to the customer before disconnecting. The delivery of the summary prior to disconnecting can trigger automated actions—e.g. sending the customer a document promised during the call, scheduling a follow-up call/email, etc.

Other potential solutions have been tried for the same problem. For example, instead of using an LLM to generate the summary, a lower-power model may be used instead. This generally leads to lower accuracy in the summary, however, which may undesirable. Similarly, low-latency LLMs may be used in place of standard LLMs. These have significantly higher cost, however, as they require more expensive hardware to run, plus they cannot be batched as effectively, which further increases their cost. Also, these are inherently smaller models, and thus (again) have lower accuracy.

The solution presented herein utilizes a phrase recognition mechanism informed by a machine learning algorithm that has learned phrases that indicate the last 10 seconds of a call, such as a current “Real-Time Enlighten Model”. This solution does not require that a summary be generated instantaneously after the call has been completed, but rather generates the summary pre-emptively when the Enlighten model predicts that the end of the call is coming in the next 10 or so seconds. The end of an interaction usually includes “social niceties” such as “thank you for your help” or “can I help you with anything else?”, which are recognizable as end-of-call indicators but are not themselves valuable to the summary.

The present disclosure can be used to improve customer experience by providing targeted notes from the call to the agent, enabling them to communicate quickly and comprehensively with the customer without pausing the conversation to manually enter notes or remember key points from the discussion. Rather, these notes will now be available instantly to the agent after a call, or even before the interaction ends, rather than requiring the normal several-second delay associated with an LLM query.

The present disclosure aids contact center interactions, by improving the availability of the call summary. Implemented on a contact center computing system in communication with an agent computing/communication device and a customer communication device, the end-of-call prediction system disclosed herein provides practical benefits in the time required to complete an interaction and perform post-interaction tasks. This improved workflow transforms a post-call summary process into one that takes place while the call is still ongoing, without the normally routine need to pause the conversation and wait for the LLM to respond. This unconventional approach improves the functioning of the contact center computing system, by reducing the total amount of computer time required to complete a contact or customer-agent interaction, thus reducing energy consumption and the greenhouse gas emissions associated therewith.

The end-of-call prediction system may be implemented as a process at least partly viewable on a display, and operated by a control process executing on a processor that accepts user inputs from a keyboard, mouse, touchscreen, or voice control interface, and that is in communication with one or more communication devices. In that regard, the control process performs certain specific operations in response to different inputs or selections made at different times. Certain outputs of the end-of-call prediction system may be printed, shown on a display, or otherwise communicated to human operators. Certain structures, functions, and operations of the processor, display, sensors, and user input systems are known in the art, while others are recited herein to enable novel features or aspects of the present disclosure with particularity.

These descriptions are provided for exemplary purposes only, and should not be considered to limit the scope of the end-of-call prediction system. Certain features may be added, removed, or modified without departing from the spirit of the claimed subject matter.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

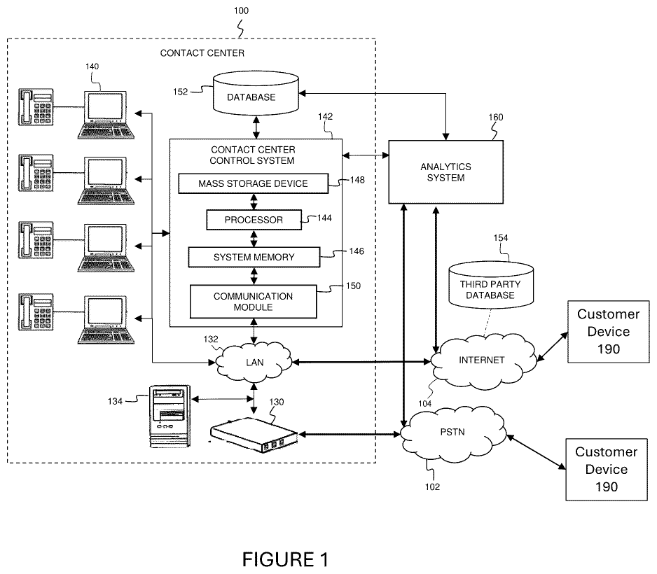

FIG. 1 is a schematic, diagrammatic representation, in block diagram form, of a contact center 100, in accordance with at least one embodiment of the present disclosure. The term “call center” or “contact center,” as used herein, can include any facility or system server suitable for receiving and recording electronic communications between agents and customers. Such contacts, interactions, or communications can include, for example, telephone calls, chats, facsimile transmissions, e-mails, web interactions, voice over IP (“VoIP”) and video. Various specific types of communications contemplated through one or more of these channels include, without limitation, email, SMS data (e.g., text), tweet, instant message, web-form submission, smartphone app, social media data, and web content data (including but not limited to internet survey data, blog data, microblog data, discussion forum data, and chat data), etc. Thus, as used herein, the term “call” (including “end-of-call” and similar uses) may refer to any of these types of ongoing real-time communications between a customer and an agent. Typically, call references a phone call, chat or DM, texting, or interactive discussion by phone, app, video, or exchanged versions of the foregoing. In some embodiments, the communications can include contact tasks, such as taking an order, making a sale, responding to a complaint, etc. In various aspects, real-time communication, such as voice, video, or both, is preferably included. It is contemplated that these communications may be transmitted by and through any type of telecommunication device and over any medium suitable for carrying data. For example, the communications may be transmitted by or through telephone lines, cable, or wireless communications. As shown in FIG. 1, the contact center 100 of the present disclosure is adapted to receive and record varying electronic communications and data formats that represent an interaction that may occur between a customer device 190 and a contact center agent computing device 140 during fulfillment of a contact and agent transaction. In one embodiment, the contact center 100 records all of the contact calls in uncompressed audio formats. In the illustrated embodiment, contacts may communicate with agents associated with the contact center 100 via multiple different communication networks such as a public switched telephone network (PSTN) 102 or the Internet 104. For example, a contact may initiate an interaction session through a customer device 190, which may be or include a traditional telephone, a fax machine, a cellular (e.g., mobile) telephone, a personal computing device with a modem, or other legacy communication device via the PSTN 102. Further, the contact center 100 may accept internet-based interaction sessions from personal computing devices, VoIP telephones, and internet-enabled smartphones and personal digital assistants (PDAs).

As one of ordinary skill in the art would recognize, the illustrated example of communication channels associated with a contact center 100 in FIG. 1 is just an example, and the contact center may accept contact interactions, and other analyzed interaction information and/or routing recommendations from an analytics center, through various additional and/or different devices and communication channels whether or not expressly described herein.

For example, in some embodiments, internet-based interactions and/or telephone-based interactions may be routed through an analytics system 160 before reaching the contact center 100 or may be routed simultaneously to the contact center and the analytics center (or even directly and only to the contact center). Also, in some embodiments, internet-based interactions may be received and handled by a marketing department associated with either the contact center 100 or analytics center 120. The analytics system 160 may be controlled by the same entity or a different entity than the contact center 100. Further, the analytics system 160 may be a part of, or independent of, the contact center 100, and may be in direct or indirect communication with the database 152, contact center control computer 142, etc.

The contact center 100 may include a contact center control system or contact center control computer 142 in communication with a local database 152. The contact center control computer 142 may include a mass storage device 148, a processor 144, a system memory 146, and a communication module 150, in communication via a local area network (LAN) 132 with a switch or router 130 capable of accessing a local server 134 and/or the Internet 104 or PSTN 102. Via the internet 104, the contact center control computer 142 may contact a third-party database 154.

Before continuing, it should be noted that the examples described above are provided for purposes of illustration, and are not intended to be limiting. Other devices and/or device configurations may be utilized to carry out the operations described herein.

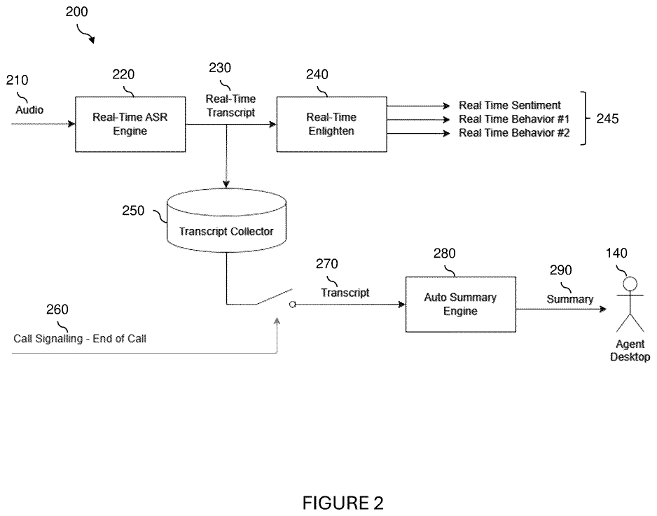

FIG. 2 is a schematic, diagrammatic representation, in block diagram form, of an existing call summary system 200, in accordance with at least one embodiment of the present disclosure. In the baseline implementation shown in FIG. 2, audio 210 from a telephone call is received by a real-time automated speech recognition (ASR) engine 220 for conversion into a real-time transcript 230. In embodiments where the communication is a chat or other text communication rather than a voice call, the transcript 230 may be the chat itself. The transcript 230 is then received by a real-time interpretation module 240 such as an Enlighten model, which produces an interpretation 245. The interpretation 245 may include real-time sentiment and a list of real-time behaviors on the part of the customer. The transcript 230 is also collected by a transcript collector 250 to produce a collected transcript 270. In an example, real-time transcripts are ephemeral, comprising short segments (which might even be single words) that are returned as soon as they are calculated. In some cases, real-time transcripts may also include corrections to previously sent segments. The transcript collector 250 is a service that collects these segments from real-time ASR, and stores them for later use.

An end-of-call signal 260 (e.g., triggered when the customer or the agent hangs up) triggers a summary 290 to be generated by passing the collected transcript 270 of the phone call (or chat, video, or other interaction as described herein) to the auto summary engine 280 (e.g., an LLM prompted by a system prompt). The output is a summary 290, which is then sent to the agent computing device 140. Thus, generation of the summary 290 occurs only after the call is complete. The problems associated with this arrangement, described above, contribute to agent inefficiency, and may limit customer satisfaction, as well as opportunities to enhance sales, collect survey information, etc.

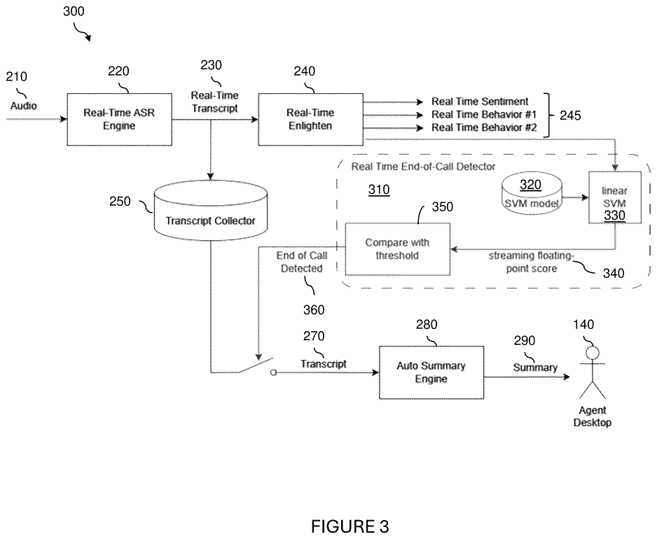

FIG. 3 is a schematic, diagrammatic representation, in block diagram form, of a call summary system 300 that incorporates the end-of-call prediction system, in accordance with at least one embodiment of the present disclosure. FIG. 3 is similar to FIG. 2, except that instead of a “hard stop” end-of-call signal 260, the system 300 uses an end-of-call detection 360 that predicts when the call is about to end, before it has actually ended.

In the example shown in FIG. 3, this is accomplished by passing data from the real-time interpretation module 240 to a real-time end-of-call detector 310. The end-of-call detector 310 may for example include a trained support vector machine model 320 which is received, along with the data from the real-time interpretation module 240, by a linear support vector machine 330, which produces a real-time numerical score 340 such as a streaming floating-point score which is compared with a threshold 350. When the score 340 exceeds the threshold 350, an end-of-call detection or prediction is issued, and the collected transcript 270 is send to the auto summary engine 280 to produce the summary 290, which is sent to the agent computing device 140 while the call is still ongoing.

To implement the system 300, a real-time end-of-call detection is used, which may be based on or added to an existing Enlighten real-time model 240. Several methods exist for building such a model. One possible implementation is a linear support vector machine (SVM) 330 that detects phrases in the real-time transcript 230, keeps a running score 340, and alerts 360 when the score 340 goes above an experimentally determined threshold 350. In an example, to implement this approach, 100,000 post-call transcripts are used to create thousands of examples of pseudo-real-time transcript segments, by simply truncating the transcript at random time offsets, typically creating one random-length segment per original transcript. Because these are post-call transcripts, the end-of-call moment is known exactly, and real-time segments can be labeled as “1” if they end within the final <10> seconds of the call, or labeled “0” if the segment ends prior to this region. Two-class linear SVM training with these transcripts can follow: create a large set of phrases where each phrase corresponds to a dimension of an SVM vector, the occurrence count of each phrase of a pseudo-real-time-transcript-segment is the value for each dimension in the vector, and the 0's and 1's for the segment are the labels for the vector. The result of such training is that each phrase gets a weight assessing that phrase's value, positive or negative, in detecting segments that are near the end of the call.

Block diagrams are provided herein for exemplary purposes; a person of ordinary skill in the art will recognize myriad variations that nonetheless fall within the scope of the present disclosure. For example, any of the blocks described herein may optionally include an output to a user of information relevant to the block, and may thus represent an improvement in the user interface over existing art by providing information (whether static or dynamically updated) that is not otherwise available.

Similarly, block diagrams may show a particular arrangement of components, modules, services, steps, processes, or layers, resulting in a particular data flow. It is understood that some embodiments of the systems disclosed herein may include additional components, that some components shown may be absent from some embodiments, and that the arrangement of components may be different than shown, resulting in different data flows while still performing the methods described herein.

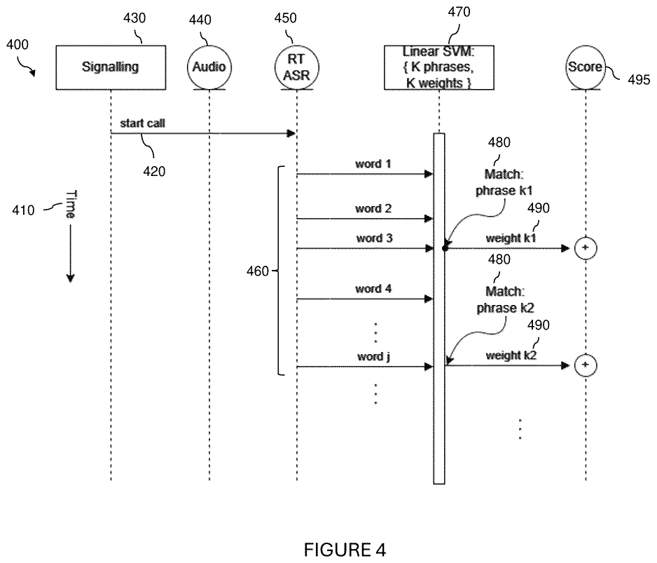

FIG. 4 is a sequence diagram 400 showing the run-time operation of a linear SVM 470, in accordance with at least one embodiment of the present disclosure. In this arrangement, the linear SVM is acting as a replacement for the computer telephony integration (CTI) end-of-call signaling. CTI is a metadata stream that accompanies the audio stream, with event notifications such as: call arrival, call answered, call transfer, etc. For particular interest in the present disclosure, one of the CTI events is a note that a call was disconnected, which then triggers post-call-processes like saving the call recording, and sending a survey. To implement this linear SVM 470 at run-time, the model can be implemented in a causal manner, as shown by the sequence diagram of FIG. 4. A signal 430 indicating the start of call 420 results in audio 440 being passed to the real-time automated speech recognition system 450. As time 410 moves forward, words 460 come out of real-time ASR 450, and each time a new word arrives, if any phrase is generated that triggers a match 480 in the linear SVM 470, the corresponding weight 490 is added to (or subtracted from, if the weight is negative) the running score. The result is a floating-point score 495 that can update each time a new word arrives from the real-time speech recognition engine 450, where a high-score relative to a threshold is a flag that the real-time transcript is approaching the end of the call. The threshold for a high-score can be manually set in advance, or determined automatically by any suitable method including by an average for a contact center, an agent or group of agents, or the like.

Once the score exceeds a pre-defined threshold (e.g., the “high-score” if above the threshold), this is used as the new trigger for Auto Summary instead of direct call signaling. Since this trigger happens before the end of the call, the summary can be available for the agent before the call has ended. Also, as discussed above, other actions could be enabled, such as creating interaction-content-dependent surveys.

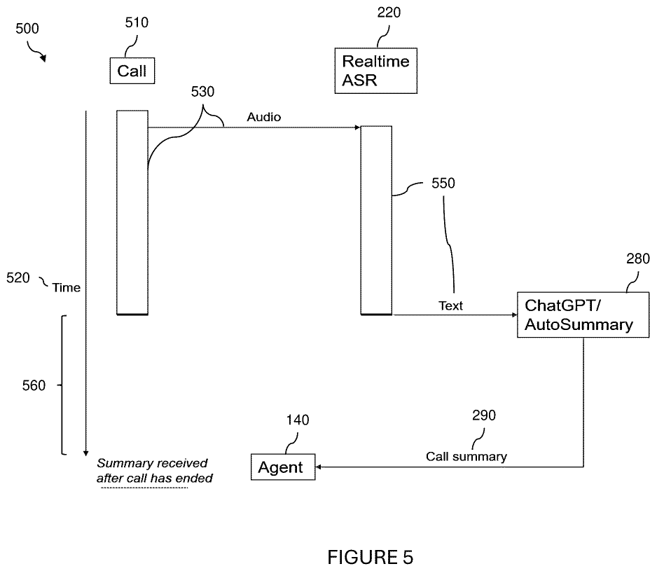

FIG. 5 is an example current auto summary sequence 500, without end-of-call detection, in accordance with at least one embodiment of the present disclosure. As time 520 moves forward, a call 510 produces audio 530 that is received by real-time ASR 220, which outputs a transcript 550. After the end of the call, the text of the transcript 550 is passed to the auto summary engine 280, which takes time (e.g., several seconds) to produce a call summary 290, which is then passed to the agent computing device 140 for display to the agent. This results in a significant time gap 560 between the end of the call 510 and the agent's receipt of the summary 290. This time gap 560 may be considered wasted time for the agent, the agent computing device, and the contact center control computer. The larger the gap 560 is, the more computing time and human labor is wasted.

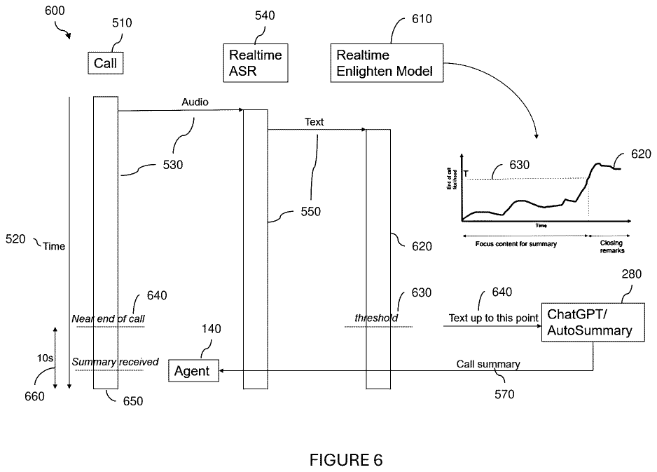

FIG. 6 is an example auto summary sequence 600 that incorporates the end-of-call prediction system, in accordance with at least one embodiment of the present disclosure. FIG. 6 is similar to FIG. 5, except that the text 550 of the call transcript is sent to a real-time interpretation model 610 (e.g., an Enlighten model or the equivalent), which generates a real-time score 620 that updates continuously as time 520 moves forward. When the score 620 exceeds a threshold 630, the partial transcript 640 (constituting the text up to that point in the call) is sent to the auto summary engine 280, which produces a call summary 570 before the actual end 650 of the call 510. Thus, there is a negative time gap 660 (in this example, about 10 seconds), which represents a net savings of computer time and human time. Additionally, this can improve customer satisfaction scores when an agent can improve outcomes by having a summary before a call ends to help discuss additional topics during that interaction.

It is noted that the prompt required for the Auto Summary LLM (“ChatGPT” in the figures, but this could be any LLM) does not need to change between the scenarios shown in FIGS. 5 and 6. The difference between these scenarios is when the transcript is provided, and thus when during the interaction the Auto Summary action is invoked.

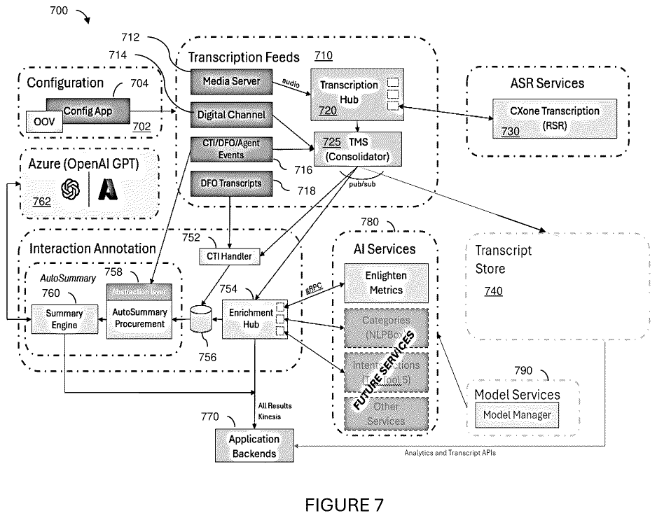

FIG. 7 is a schematic, diagrammatic representation, in block diagram form, of an existing call summary system 700, in accordance with at least one embodiment of the present disclosure. In the example shown in FIG. 7, a configuration module 702 uses a configuration application 704 to configure the transcription feeds 710, which include a media server 712, digital channel 714, CTI/digital first omnichannel (DFO) agent events 716, and DFO Transcripts 718. Audio from the media server 712 is fed to the transcription hub 720, uses a transcription service 730 to generate a transcript, and passes the transcript to the transcript media store (TMS) consolidator 725. From there, the transcript is passed to the transcript store 740, and also to the CTI handler 752 and enrichment hub 754, both of which communicate with a database 756. An auto summary procurement module 758 then passes the transcript, and a system prompt, to the summary engine 760, which passes it to the LLM 762. The enrichment hub 754 also communicates with application backends 770, and with artificial intelligence (AI) services 780, which can for example include the Enlighten metrics 245 shown in FIG. 2. The AI services 780 may communicate with model services 790 that control or support the AI models.

The end-of-call prediction system fits into this existing product framework, by adding end-of-call prediction to the real-time Enlighten models of the AI services 780, and changing the trigger for calling the Auto Summary LLM from “end-of-call” to “predictor goes above some threshold”.

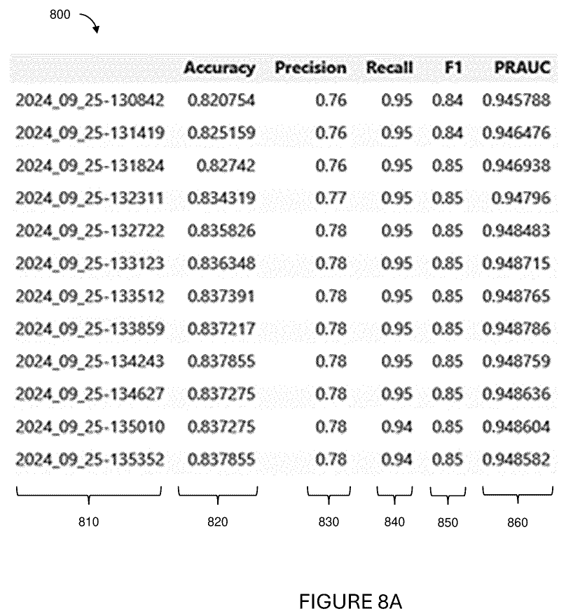

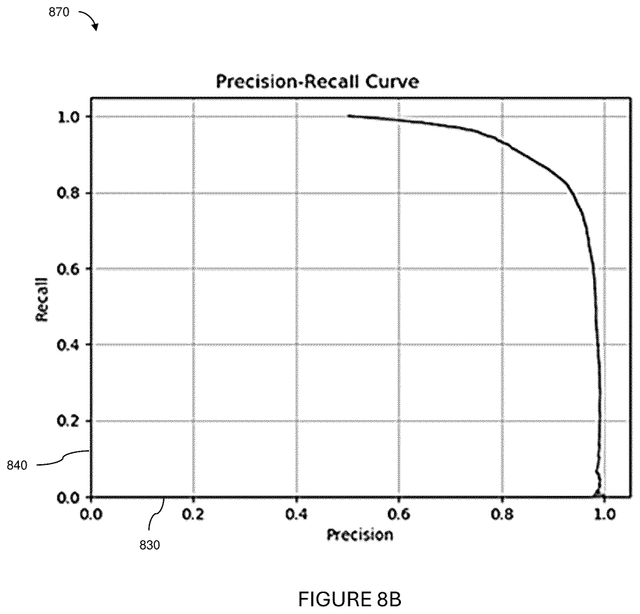

FIG. 8A is a test output 800 for an example end-of-call prediction system, in accordance with at least one embodiment of the present disclosure. In the example shown in FIG. 8, a machine learning algorithm is used to detect the end of the call. The algorithm is trained on ~100K call transcriptions. The transcriptions were split into two parts: Start of the call to the start of the last 10 seconds, and the last 10 seconds of the call. The first portion is labeled as 0 (this is not part of the last 10 seconds) and the second portion is labeled as 1 (this is the last 10 seconds of the call). The algorithm is trained to identify phrases that indicate that the call is in the last 10 seconds. The model is a set of phrases as long with a numerical weight that indicates how strongly the phrase signals the end of the call, or how strongly the phrase signals the portion of the call prior to the last 10 seconds.

A machine learning model was created to detect, from a real-time transcription or chat stream, if an interaction has 10 or fewer seconds remaining (the “End-of-call Detector model” described above). After several experiments, the chosen model yielded an accuracy (the model's overall performance in identifying whether the call is within the last 10 seconds or not) of 84%, precision (the model's performance when identifying calls within the last 10 seconds (i.e. of all the calls predicted to be in the last 10 seconds, how many were actually in the last 10 seconds) of 78%, and recall (proportion of calls that were actually in the last 10 seconds that were correctly identified by the model) of 95%. In an example, a table 800 is used to compare against those from other experiments to determine the best model based on the balance between achieved precision and recall, which are in contention with each other. In the chosen model, the recall score of 95% corresponds to a precision score of 78%. The test output 800 shows results of several experimental setup for such detectors. The test output 800 incudes sample IDs 810, as well as, for each sample, an accuracy 820, a precision 830, a recall 940, an F1 850, and a “precision recall area under curve” (PRAUC) 860, which will be familiar to a person of ordinary skill in the art.

In all cases, a threshold was chosen to get 95% recall. In these cases, Auto Summary can begin 10.0 seconds before then end of the call. If summarization takes 3.0 seconds, those are ready 7 seconds prior to the call end. For the remaining 5%, the CTI event (e.g., when the customer or the agent hangs up the call or disconnects the chat) ensures that summarization starts no later than the actual end-of-call, as detailed in Table 1 below.

TABLE 1
Latency: time from end-of-call until Auto-Summary is
available. Negative values mean the summary is
available prior to the end of the call.

| | Average time after call until |
|---|---|
| Call set | summary is available |
| 95% | −7.0 seconds |
| 5% | +3.0 seconds |

Thus, in 5% of cases, the system performs with no improvement or degradation over existing systems, whereas in 95% of cases it performs substantially better.

FIG. 8B is a plot 870 of precision 830 vs. recall 840, in accordance with at least one embodiment of the present disclosure. The plot 870 shows the recall score 840 and precision score 830 for each threshold tested within the output score range. The table in FIG. 8A shows the overall results (accuracy, precision, recall, PRAUC) of each experimental model. Each model outputs a set of numeric scores (between some minimum value and some maximum value without any preset bound) and a threshold is chosen to determine the final label. The threshold is such that any input that the model scores above the threshold is determined to be within the last 10 seconds of the call, and any input that the model scores below the threshold is determined to be outside of the last 10 seconds of the call. Based on the threshold chosen, the model will yield different precision and recall curves. In some cases, the system may create the Precision-Recall curve, which plots the precision and recall scores for a number of thresholds in the score range, to visualize the optimized precision and recall.

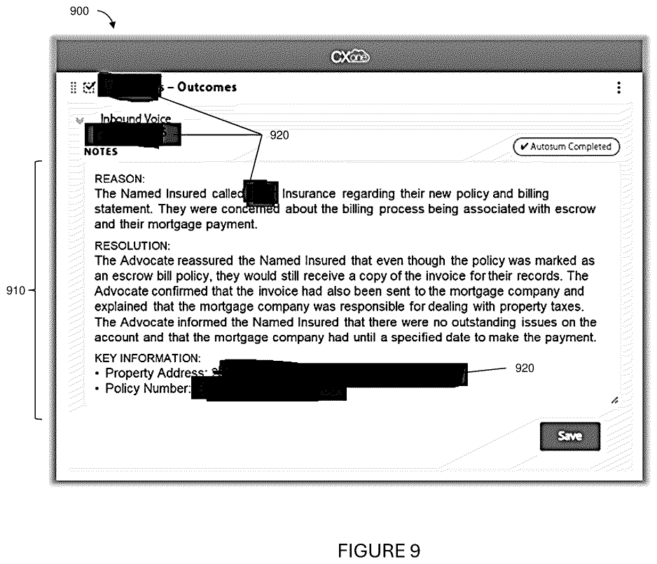

FIG. 9 is an example auto summary output 900 that may for example be displayed on an agent computing device via the GUI, in accordance with at least one embodiment of the present disclosure. The auto summary output 900 includes summary information 910 as well as redacted or masked personally identifying information (PII) 920. In some embodiments, PII may not be redacted or masked. Regardless of whether the end-of-call prediction system is employed, the contents of the auto-summary itself do not change. Rather, what changes is when this summary is available changes. In the current product, the summary appears several seconds after a caller has disconnected. However, when the end-of-call prediction system is employed, this same summary output 900 would be available around 7 seconds prior to the caller leaving. The auto summary output 900 also includes a user control 930 that can be activated to save the output and to trigger automated actions such as sending the customer a document promised during the call or chat, scheduling a follow-up call or chat, scheduling a follow-up email, generating an interaction-appropriate survey, or transferring the call or chat to a second agent (e.g., escalating to a supervisor or subject matter expert).

In some embodiments, the auto summary output 900 is displayed in an editable window, in which the agent can type to add missing information, remove unnecessary information, redact PII, etc.

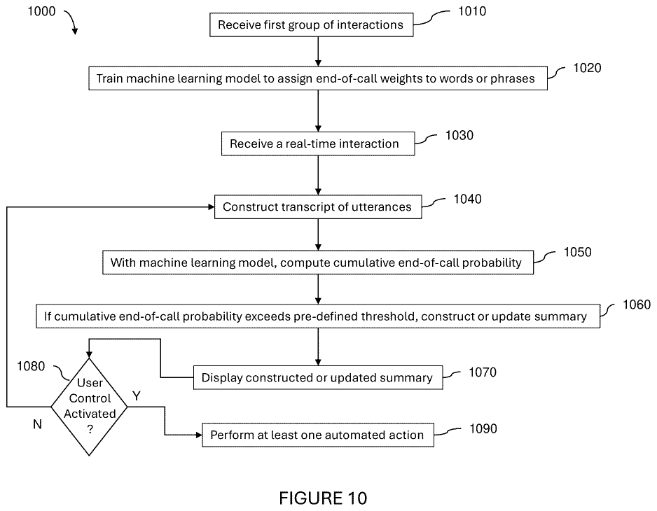

FIG. 10 is a schematic, diagrammatic representation, in flow diagram form, of a call summary method 1000 that employs the end-of-call prediction system, in accordance with at least one embodiment of the present disclosure. It is understood that the steps of method 1000 may be performed in a different order than shown in FIG. 10, additional steps can be provided before, during, and after the steps, and/or some of the steps described can be replaced or eliminated in other embodiments. One or more of steps of the method 1000 can be carried by one or more devices and/or systems described herein, such as components of system 100, system 300, and/or processor circuit 1150.

In step 1010, the method 1000 includes receiving a first group of interactions, such as call or chat transcripts. Execution then proceeds to step 1020.

In step 1020, the method 1000 includes training a machine learning model (e.g., a support vector machine or other lightweight model) to assign end-of-call weights to words or phrases that occur in the transcripts. Execution then proceeds to step 1030.

In step 1030, the method 1000 includes receiving a real-time interaction such as a ongoing voice call or text chat. Execution then proceeds to step 1040.

In step 1040, the method 1000 includes constructing a real-time transcript of utterances in the real-time interaction, while the interaction is ongoing. Execution then proceeds to step 1050.

In step 1050, the method 1000 includes, with the machine learning model, computing a cumulative and of call probability by adding the weights of words or phrases detected in the transcript. Execution then proceeds to step 1060.

In step 1060, the method 1000 includes, if the cumulative end-of-call probability exceeds a pre-defined threshold, constructing or updating a summary of the transcript. Execution then proceeds to step 1070.

In step 1070, the method 1000 includes displaying the constructed or updated summary (e.g., to the agent, via the agent computing device). Execution then proceeds to step 1080.

In step 1080, the method 1000 includes determining whether a “save summary” user control has been activated. If no, execution returns to step 1040. If yes, execution then proceeds to step 1090.

In step 1090, the method 1000 includes saving the summary and performing at least one additional automated action based on the content of the summary, such as sending the customer a document promised during the call or chat, scheduling a follow-up call or chat, scheduling a follow-up email, generating an interaction-appropriate survey, or transferring the call or chat to a second agent (e.g., escalating to a supervisor or subject matter expert). The method 1000 is now complete.

Flow diagrams are provided herein for exemplary purposes; a person of ordinary skill in the art will recognize myriad variations that nonetheless fall within the scope of the present disclosure. For example, any of the steps described herein may optionally include an output to a user of information relevant to the step, and may thus represent an improvement in the user interface over existing art by providing information (whether static or dynamically updated) that is not otherwise available.

Similarly, the logic of flow diagrams may be shown as sequential. However, similar logic could be parallel, massively parallel, object oriented, real-time, event-driven, cellular automaton, or otherwise, while accomplishing the same or similar functions. In order to perform the methods described herein, a processor may divide each of the steps described herein into a plurality of machine instructions, and may execute these instructions at the rate of several hundred, several thousand, several million, or several billion per second, in a single processor or across a plurality of processors. Such rapid execution may be necessary in order to execute the method in real time or near-real time as described herein, and thus produce the described improvement in user interfaces.

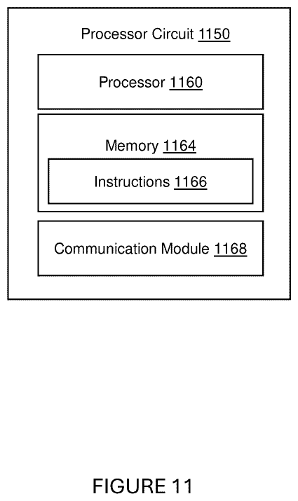

FIG. 11 is a schematic diagram of a processor circuit 1150, in accordance with at least one embodiment of the present disclosure. The processor circuit 1150 may be implemented in the system 100, the system 300, the system 700, or other devices or workstations (e.g., third-party workstations, network routers, etc.), or on a cloud processor or other remote processing unit, as necessary to implement the method. As shown, the processor circuit 1150 may include a processor 1160, a memory 1164, and a communication module 1168. These elements may be in direct or indirect communication with each other, for example via one or more buses.

The processor 1160 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 1160 may also comprise another hardware device, a firmware device, or any combination thereof configured to perform the operations described herein. The processor 1160 may also be implemented as a combination of computing devices, e.g., a combination of a DSP and a microprocessor, a plurality of microprocessors, one or more microprocessors in conjunction with a DSP core, or any other such configuration.

The memory 1164 may include a cache memory (e.g., a cache memory of the processor 1160), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 1164 includes a non-transitory computer-readable medium. The memory 1164 may store instructions 1166. The instructions 1166 may include instructions that, when executed by the processor 1160, cause the processor 1160 to perform the operations described herein. Instructions 1166 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 1168 can include any electronic circuitry and/or logic circuitry to facilitate direct or indirect communication of data between the processor circuit 1150, and other processors or devices. In that regard, the communication module 1168 can be an input/output (I/O) device. In some instances, the communication module 1168 facilitates direct or indirect communication between various elements of the processor circuit 1150 and/or the system 100, 300, or 700. The communication module 1168 may communicate within the processor circuit 1150 through numerous methods or protocols. Serial communication protocols may include but are not limited to United States Serial Protocol Interface (US SPI), Inter-Integrated Circuit (I2C), Recommended Standard 232 (RS-232), RS-485, Controller Area Network (CAN), Ethernet, Aeronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

External communication (including but not limited to software updates, firmware updates, preset sharing between the processor and central server, etc.) may be accomplished using any suitable wireless or wired communication technology, such as a cable interface such as a universal serial bus (USB), micro USB, Lightning, or Fire Wire interface, Bluetooth, Wi-Fi, ZigBee, Li-Fi, or cellular data connections such as 2G/GSM (global system for mobiles), 3G/UMTS (universal mobile telecommunications system), 4G, long term evolution (LTE), WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

As will be readily appreciated by those having ordinary skill in the art after becoming familiar with the teachings herein, the end-of-call prediction system advantageously permits a call or chat summary to be presented to a contact center agent while the call is still ongoing, thus saving both labor and computing time, reducing waste, and permitting additional actions to be taken while the customer is still on the line. A number of variations are possible on the examples and embodiments described above. For example, different kinds of machine learning models may be used, instead of or in additional to the support vector machines and large language models described herein. The technology described herein may be applied to contact centers of various kinds, including but not limited to customer support, technical support, sales, and emergency services.

Accordingly, the logical operations making up the embodiments of the technology described herein are referred to variously as operations, steps, objects, elements, components, or modules. Furthermore, it should be understood that these may occur, or may be performed or arranged, in any order, unless explicitly claimed otherwise or a specific order is inherently necessitated by the claim language.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the end-of-call prediction system. Connection references, e.g., attached, coupled, connected, joined, or “in communication with” are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting. The term “real time” is intended to mean within a second or two, such as 0.3 or 0.5 or 0.8 seconds, but could encompass delays of up to five seconds.

The above specification, examples and data provide a complete description of the structure and use of exemplary embodiments of the end-of-call prediction system as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A system adapted to, for a contact center, automatically display a summary of a customer-agent interaction before an end of the interaction, the system comprising:
an agent computing device having a processor and a non-transitory computer readable medium operably coupled thereto, the agent computing device comprising a graphical user interface (GUI) and being in electronic communication with a contact center control system, the contact center control system comprising: a real-time automated speech recognition system and a summary engine, the computer readable medium comprising a plurality of instructions stored in association therewith that are accessible to, and executable by, the processor, to perform operations which comprise:
with the contact center control system, over a first period of time:
receiving a first plurality of interactions from a plurality of customers, each interaction comprising a plurality of phrases and an end; and
with a training system, training a machine learning model to assign an end-of-call probability weight to each phrase of the plurality of phrases, based on a proximity of each phrase to the end; and
with the contact center control system, at a time after the first period of time:
receiving an interaction from a further customer different from the first plurality of interactions, the interaction comprising a plurality of utterances;
connecting the interaction to the agent computing device;
in real time, constructing a transcript of the utterances;
in real time, with the trained machine learning model, computing a cumulative end-of-call probability based on the plurality of utterances that updates with each new utterance of the plurality of utterances;
in real time, if the cumulative end-of-call probability exceeds a threshold value then, with the summary engine, constructing or updating a summary of the transcript;
with the GUI, displaying a user control and the summary or the updated summary to an agent prior to an end of the interaction;
when the user control is activated:
saving the summary; and
performing at least one automated action based on content within the summary or within the updated summary.

2. The system of claim 1, wherein the at least one automated action comprises sending the customer a document promised during the interaction, scheduling a follow-up call, scheduling a follow-up email, generating an interaction-appropriate survey, or transferring the interaction to a second agent.

3. The system of claim 1, wherein the summary engine comprises a large language model or the machine learning model comprises a linear support vector machine.

4. The system of claim 1, wherein displaying the summary and the user control prior to the end of the interaction results in a time savings for the agent, an improved user experience for the agent, or an improved customer experience for the customer.

5. The system of claim 1, wherein the operations further comprise:
displaying the summary in an editable window; and
receiving edits to the summary from the agent via the GUI.

6. The system of claim 1, wherein the operations further comprise:
in real time, based on the transcript, determining at least one of a customer sentiment, a first customer behavior, or a second customer behavior.

7. The system of claim 1, wherein the contact is a voice call, and wherein constructing the transcript involves the real-time automated speech recognition system.

8. The system of claim 1, wherein the contact is a text chat, and wherein constructing the transcript involves storing text of the text chat.

9. The system of claim 1, wherein the operations further comprise sending an interaction-appropriate survey to the customer.

10. The system of claim 1, wherein phrases with a high end-of-call probability weight comprise social niceties with low information content, and wherein excluding the social niceties from the summary has low impact on an information content of the summary.

11. A method for, in a contact center, automatically displaying a summary of a customer-agent interaction before an end of the interaction, the method comprising:
with a contact center control system comprising a real-time automated speech recognition system and a summary engine, over a first period of time:
receiving a first plurality of interactions from a plurality of customers, each contact comprising a plurality of phrases and an end; and
with a training system, training a machine learning model to assign an end-of-call probability weight to each phrase of the plurality of phrases, based on a proximity of each phrase to the end; and
with the contact center control system, at a time after the first period of time:
receiving an interaction different from the first plurality of interactions from a customer different from the plurality of customers, the interaction comprising a plurality of utterances;
connecting the interaction to an agent computing device;
in real time, constructing a transcript of the utterances;
in real time, with the trained machine learning model, computing a cumulative end-of-call probability based on the plurality of utterances that updates with each new utterance of the plurality of utterances;
in real time, if the cumulative end-of-call probability exceeds a threshold value then, with the summary engine, constructing or updating a summary of the transcript;
with a graphical user interface (GUI) running on the agent computing device, displaying a user control and the summary or the updated summary to an agent prior to an end of the interaction; and
when the user control is activated:
saving the summary; and
performing at least one automated action based on content within the summary or within the updated summary.

12. The method of claim 11, wherein the at least one automated action comprises sending the customer a document promised during the interaction, scheduling a follow-up call, scheduling a follow-up email, generating an interaction-appropriate survey, or transferring the interaction to a second agent.

13. The method of claim 11, wherein the summary engine comprises a large language model or the machine learning model comprises a linear support vector machine.

14. The method of claim 11, wherein displaying the summary and the user control prior to the end of the contact results in a time savings for the agent, an improved user experience for the agent, or an improved customer experience for the customer.

15. The method of claim 11, further comprising:
displaying the summary in an editable window; and
receiving edits to the summary from the agent via the GUI.

16. The method of claim 11, further comprising:
in real time, based on the transcript, determining at least one of a customer sentiment, a first customer behavior, or a second customer behavior.

17. The method of claim 11, wherein the interaction is a voice call, and wherein constructing the transcript involves the real-time automated speech recognition system.

18. The method of claim 11, wherein the interaction is a text chat, and wherein constructing the transcript involves storing text of the text chat.

19. The method of claim 11, further comprising sending an interaction-appropriate survey to the customer.

20. The method of claim 11, wherein phrases with a high end-of-call probability weight comprise social niceties with low information content, and wherein excluding the social niceties from the summary has low impact on an information content of the summary.
